(19) United States
(12) Patent Application Publication
(10) Pub. No.: US 2010/0062170 A1
(43) Pub. Date: Mar. 11, 2010

(54) Method of manufacturing antiskid protective glove

(75) Inventors: Xiaolin Sha, Nantong (CN); Yan Sha, Nantong (CN)

Correspondence Address: ZHEN ZHENG LU, 1730 HUNTINGTON DRIVE #304, DUARTE, CA, 91010, US

(73) Assignee: Nantong Qiangsheng Light Textile Technology Co., Ltd.

(21) Appl. No.: 12/233,591

(22) Filed: Sep. 19, 2008

(30) Foreign Application Priority Data
Sep. 8, 2008 (CN) 200810042632.9

(51) Int. Cl. B05D 3/00

(52) U.S. Cl. 427/389.9

(57) ABSTRACT

A method of manufacturing antiskid protective glove comprises steps of (a) providing a glove base; (b) dipping the glove base with latex forming a latex layer thereon; (c) sprinkling particles on the latex layer, wherein the particles interacts with the latex forming a creasy surface thereon; (d) drying the latex layer, (e) washing out the unreacted particles; and (f) drying the protective glove, wherein no particular or stink smell is discharged during this manufacturing method.

### BACKGROUND OF THE PRESENT INVENTION

1. Field of Invention

The present invention relates to a method of manufacturing protective glove, and more particularly to a method of manufacturing antiskid protective glove having antiskid function, wherein no particular or stink smell is discharged during manufacturing procedure.

2. Description of Related Arts

At present, when the knitted glove, cloth glove or leather glove base is dipped with all kinds of nature latex, synthetic latex or synthetic resin, such as natural latex, NBR latex, PU or PVC, a protective layer is formed on the glove base to create its chemical proof function.

Furthermore, the protective glove is dipped and corroded in a solvent to create a creasy surface thereon so as to improve its antiskid function. However, the solvent has to be chemicals like xylene, solvent oil, acetic acid, benzoic acid, and so on, so that pretty much particular or stink smell is produced during the corroding process. The particular or stink smell is harm to the environment and the operating personnel. At the same time, the cost of the corroding process is high too. In addition, such protective glove is not wear-resistant and will be easily cracked.

### SUMMARY OF THE PRESENT INVENTION

An object of the present invention is to provide a method of manufacturing antiskid protective glove, wherein no particular or stink smell is discharged during manufacturing procedure.

Another object of the present invention is to provide a method of manufacturing antiskid protective glove, comprising a step of sprinkling salt on the latex layer so as to produce a creasy surface thereon, wherein creasy surface produced in this procedure is fine-grained and soft, so that the glove is wear-resistant and not easily cracked.

Another object of the present invention is to provide a method of manufacturing antiskid protective glove, wherein low cost salt or ammonium bicarbonate is used, so as to lower the total cost of creating creasy surface to more than 50%.

Another object of the present invention is to provide a method of manufacturing antiskid protective glove, wherein the original mechanism of producing creasy surface and dipping production line are only slightly altered, while other producing parts and process remain. The total production line is still automatic and continuous.

Accordingly, in order to accomplish the above object, the present invention provides a method of manufacturing antiskid protective glove, comprising steps of:

(a) providing a glove base;

(b) dipping the glove base with latex forming a latex layer thereon;

(c) sprinkling salt on the latex layer, wherein the salt interacts with the latex forming a creasy surface thereon;

(d) drying the latex layer;

(e) washing out the unreacted salt; and

(f) drying the protective glove.

The present invention is further illustrated with the following detailed description.

### DETAILED DESCRIPTION OF THE PREFERRED EMBODIMENT

A method of manufacturing antiskid protective glove of the present invention is illustrated in the preferred embodiment, wherein the method comprises steps of:

(a) providing a glove base;

(b) dipping the glove base with latex forming a latex layer thereon;

(c) sprinkling particles on the latex layer, wherein the particles interacts with the latex forming a creasy surface thereon; and

(d) drying the latex layer.

The method of manufacturing antiskid protective glove of the preferred embodiment further comprises steps of:

(e) washing out the unreacted particles; and

(f) drying the protective glove.

In step (a), the glove base may be knitted glove, cloth glove or leather glove. The knitted glove may take nylon or terylene as material and is knitted by 10-pin, 13-pin, or 15-pin knitting machine. The cloth glove may use knitted fabric or woven fabric gloves as cloth base. The leather glove use natural leather or synthetic leather as glove base. In the preferred embodiment, special yarn can also be used as glove base, such as anti-cut yarn, heat-resistant yarn, anti-bacterial yarn, wear-resistant yarn and so on, so as to enhance the protection ability. In addition, long gloves, sports gloves, casual gloves, and other life gloves can also be used as glove base.

In step (b), the latex layer is fully coated on the glove base, so as to create its chemical-proof function. The latex can be natural or chemical latex including NBR latex, natural latex, PVC, PU, and so on. Furthermore, the above mentioned types of latex can be mixed for use according to a formula.

The particles can also be embodied as powder. In step (c), the particles may be salt, ammonium bicarbonate or the like materials, which will quickly interact with the latex of the latex layer and form a creasy surface thereon, so as to improve the antiskid performance of the protective glove. Preferably, particles are sprinkled on the latex layer of a palm side of the glove base, so as to create a creasy surface on a palm side of the glove base.

Furthermore, particles are evenly sprinkled on the latex layer of a palm side of the glove base, so that the creasy surface produced in this procedure is fine-grained and soft, so that the glove is wear-resistant and not easily cracked. No particular or stink smell is discharged during this step. The cost of the salt or ammonium bicarbonate is very low so as to lower the total cost of creating creasy surface step to more than 50%. The original mechanism of creating creasy surface and dipping production line are only slightly altered, while other producing parts and process remain. The total production line is still automatic and continuous.

What is claimed is:

1. A method of manufacturing antiskid protective glove comprising:
(a) providing a glove base;
(b) dipping said glove base with latex forming a latex layer thereon;
(c) sprinkling particles on said latex layer, wherein said particles interacts with said latex forming a creasy surface thereon; and
(d) drying said latex layer.

2. The method of manufacturing antiskid protective glove, as recited in claim 1, further comprising steps of:
(e) washing out said unreacted particles; and
(f) drying said protective glove.

3. The method of manufacturing antiskid protective glove, as recited in claim 1, said particles can be embodied as powder.

4. The method of manufacturing antiskid protective glove, as recited in claim 2, said particles can be embodied as powder.

5. The method of manufacturing antiskid protective glove, as recited in claim 1, wherein said particles is salt.

6. The method of manufacturing antiskid protective glove, as recited in claim 2, wherein said particles is salt.

7. The method of manufacturing antiskid protective glove, as recited in claim 3, wherein said particles is salt.

8. The method of manufacturing antiskid protective glove, as recited in claim 1, wherein said particles is ammonium bicarbonate.

9. The method of manufacturing antiskid protective glove, as recited in claim 2, wherein said particles is ammonium bicarbonate.

10. The method of manufacturing antiskid protective glove, as recited in claim 3, wherein said particles is ammonium bicarbonate.

11. The method of manufacturing antiskid protective glove, as recited in claim 1, wherein said particles are sprinkled on said latex layer of a palm side of said glove base, so as to create a creasy surface on a palm side of said glove base.

12. The method of manufacturing antiskid protective glove, as recited in claim 2, wherein said particles are sprinkled on said latex layer of a palm side of said glove base, so as to create a creasy surface on a palm side of said glove base.

13. The method of manufacturing antiskid protective glove, as recited in claim 6, wherein said particles are sprinkled on said latex layer of a palm side of said glove base, so as to create a creasy surface on a palm side of said glove base.

14. The method of manufacturing antiskid protective glove, as recited in claim 9, wherein said particles are sprinkled on said latex layer of a palm side of said glove base, so as to create a creasy surface on a palm side of said glove base.

15. The method of manufacturing antiskid protective glove, as recited in claim 1, wherein said particles are evenly sprinkled on said latex layer.

16. The method of manufacturing antiskid protective glove, as recited in claim 2, wherein said particles are evenly sprinkled on said latex layer.

17. The method of manufacturing antiskid protective glove, as recited in claim 13, wherein said particles are evenly sprinkled on said latex layer.

18. The method of manufacturing antiskid protective glove, as recited in claim 14, wherein said particles are evenly sprinkled on said latex layer.

19. The method of manufacturing antiskid protective glove, as recited in claim 1, wherein said latex is made of material selected from a group consisting of NBR latex, natural latex, PVC, and PU.

20. The method of manufacturing antiskid protective glove, as recited in claim 2, wherein said latex is made of material selected from a group consisting of NBR latex, natural latex, PVC, and PU.
